(19) United States
(12) Patent Application Publication
(10) Pub. No.: US 2004/0077343 A1
(43) Pub. Date: Apr. 22, 2004

(54) Access method, through telephone network, from abroad, to a service portal

(76) Inventor: Michel Vermande, Montreuil Sur Epte (FR)

Correspondence Address: QUARLES & BRADY LLP, 411 E. WISCONSIN AVENUE, SUITE 2040, MILWAUKEE, WI, 53202-4497, US

(21) Appl. No.: 10/450,460

(22) PCT Filed: Dec. 12, 2001
(86) PCT No.: PCT/FR01/03964

(30) Foreign Application Priority Data
Dec. 13, 2000 (FR) 00/16223

(51) Int. Cl. H04Q 7/20; H04M 11/00

(52) U.S. Cl. 455/421

(57) ABSTRACT

The invention concerns a method enabling a subscriber (1) of a telephone network (2) and of a service portal (4) of a first country to access the portal from a second country, the access to the portal being carried out by filtering the subscriber data and access to the telephone network (2) of the first country from the second country being obtained by roaming. Therefor, the method consists in prior automatic search of a telephone network (7) of the second country designed to transmit abroad subscriber data to be filtered. The invention is particularly applicable to mobile WAP telephones.

The field of the invention is that of access, starting from a data processing terminal, more particularly, a mobile terminal of a cellular radiotelephone network, at a subscriber data filtering service, and more particularly, to service portals of an information network, more particularly, INTERNET, for example, a WAP portal.

With a mobile telephone, one must also have a subscription to one of the cellular telephone network operators. There are actually three of these in France.

The filtering carried out by a WAP portal can be carried out by identification recognition of the caller with the aid of a CLIP and, above all, with the aid of a national telephone operator.

When a subscriber of a telephone operator leaves his national territory, he may always have access to the network of his national operator but after a roaming phase to reach his national operator through a foreign telephone operator having a roaming agreement with his national operator.

In certain foreign countries, there are telephone operators who do not transmit the CLIP beyond their borders.

This results in a problem of accessibility to national WAP portals.

The invention of the present application wishes to offer a solution to this problem.

For this purpose, it is concerned with a method for accessing a service portal, a method in which a subscriber of a telephone network and a service portal of a first country can access the portal from a second country, the access to the portal being done by filtering subscriber data and access to the telephone network of the first country from the second party being carried out by roaming, a method in which one proceeds with a prior automatic search of a telephone network of the second party arranged to transmit subscriber data to be filtered to the foreign country.

In a preferred mode of embodiment of the invention, the prior automatic search is carried out by query to and response from an operator of the telephone network of the first country of the subscriber.

In this case, the subscriber may ask the operator of the network of the first country, by sending a short message [literal translation] or a data message via any telephone network of the second country.

Still in this case, an operator of the telephone network of the first country of the subscriber may query a data base before sending the response via a short message or data message.

Advantageously, the subscriber may change from the telephone network of the second country after roaming.

Again, preferably, the access to the service portal of the first country is done by filtering the identification data of the subscriber.

The invention will be understood better with the aid of the following description of execution of a preferred method with reference to the attached drawing on which

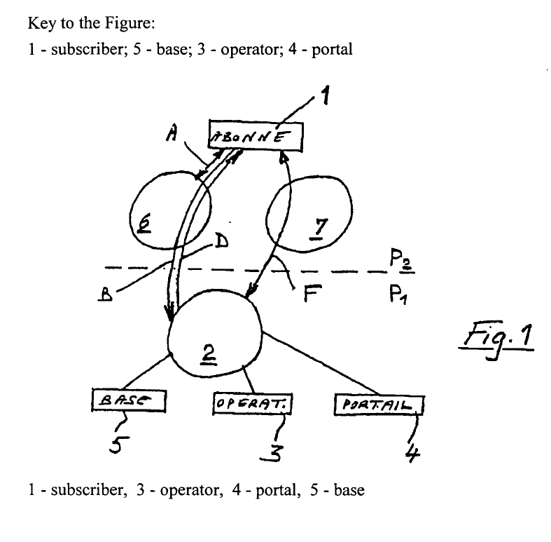

FIG. 1 shows schematically the organization of the structural links supporting the method, and

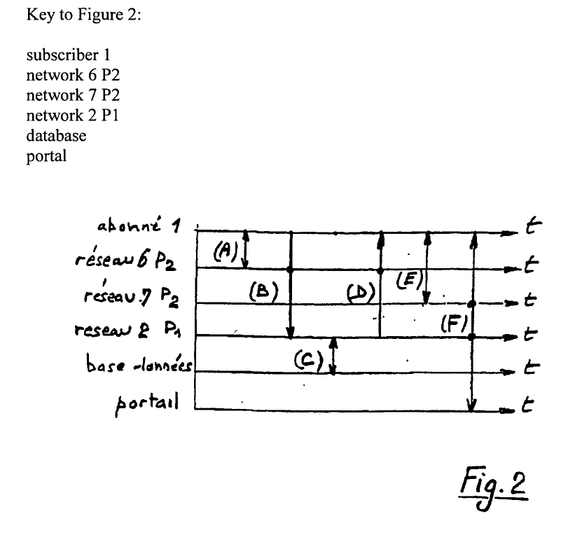

FIG. 2, which is a histogram of the establishment of the functional links of the method.

Let us use numeral 1 to describe the subscriber of the first telephone network 2 in the country of origin P1 of the subscriber. Telephone network 2 here is a cellular radiotelephone network with an operator 3. The subscriber 1 of network 2 is also a subscriber of a service portal 4 which he can access through network 2. In the present case, portal 4 is a WAP portal. The access to portal 4 is done by filtering the data of its own subscribers, in this case, by surveying the telephone identification of the caller with the aid of a CLIP provided by network 2. Operator 3 of network 2a has a database 5 at his disposal, which can be accessed directly or, as in the example under consideration, via his network 2, a database which contains a list of foreign operators with their characteristics and, notably here, the ability to provide a CLIP beyond their borders.

Let us consider that subscriber 1 is in a foreign country, in a second country P2 and that he wishes to access portal 4. During the first connection in country P2, his mobile phone calls on a first network any of R1, P2 6. Network 6 indicates to the telephone of the subscriber 1 that he is on this network and naturally that he is in country P2 (step A of FIG. 2).

Automatically, the mobile telephone of subscriber 1 sends either by short message or by a data message to his operator 3 of country P1, the information he now is in country P2, via network 6, the operator of which has a roaming agreement with operator 3 of network 2 (step B, with, on FIG. 2, an arrow starting from subscriber 1 and reaching network 2 of P1, and materially crossing the line of network 6 of P2).

Then, the network 6 of P1 queries automatically the database 5 to determine that or those of networks of P2 which can transmit CLIP to the foreign country (step C). Since network 6 of P2 does not satisfy this requirement, operator 3 sends to subscriber 1, still via the network 6 of P2, either via a short message or with a data message, the information of the networks of country P2 that satisfy the requirement (step D).

Then all the subscriber 1 has to do is to proceed to roaming to disconnect from network 6 of P2, choose and connect to on another network of P2, for example, network 7 (step E) with the aid of which, as well as with the aid of network 2 of P1, he will be able to access portal 4 (step F).

The roaming operation of subscriber 1 can be done automatically or manually with the aid of the network selection menu on his mobile phone. In the selection of the network, the cost of communication may be shown as well as the quality of the radio connection.

1. Method so that a subscriber (1) of a telephone network (2) and of a service portal (4) of a first country can access the portal from a second country, the access to the portal being carried out by subscriber data filtering and access to the telephone network (2) of the first country from the second country being done by roaming, a method in which prior automatic search (A-E) from a telephone network (7) of the second country is carried out to transmit to the foreign country the subscriber data to be filtered.

2. Method according to claim 1, in which the prior automatic search is carried out by query of and response to an operator (3) of the telephone network (2) of the country of the subscriber (1).

3. Method according to claim 2 in which the subscriber (1) queries (B) the operator (3) of network (2) of the first country by sending a short message or a data message through any telephone network (6) of the second country.

4. Method according to one of claims 2 and 3, in which the operator (3) of the telephone network (2) of the first country queries a database (5) before sending the response.

5. Method according to claim 4, in which the operator (3) sends his response by short message or a data message.

6. Method according to one of claims 1 to 5, in which the subscriber (1) changes (E) from the telephone network of the second country after roaming.

7. Method according to one of claims 1 to 6, in which access to the service portal (4) of the first country is done by filtering the identification data of the caller.
